(19) United States
(12) Patent Application Publication
(10) Pub. No.: US 2020/0041944 A1
(43) Pub. Date: Feb. 6, 2020

(54) IMAGE FORMING APPARATUS, METHOD FOR CONTROLLING THE SAME, AND IMAGE FORMING SYSTEM

(71) Applicant: CANON KABUSHIKI KAISHA, Tokyo (JP)

(72) Inventor: Kou Hiraike, Nagareyama-shi (JP)

(21) Appl. No.: 16/520,620

(22) Filed: Jul. 24, 2019

(30) Foreign Application Priority Data
Jul. 31, 2018 (JP) 2018-144029

(51) Int. Cl. G03G 15/00; G03G 15/08

(52) U.S. Cl. CPC G03G 15/556; G06F 3/1278; G03G 15/5079; G03G 15/0856

(57) ABSTRACT

An image forming apparatus acquires a remaining amount of a consumable part that is detachably mounted to the image forming apparatus and is used for image forming. The apparatus predicts a remaining number of days, which is a number of days remaining in which the consumable part can be used, based on a change of the acquired remaining amount, and notifies a server apparatus, which performs processing for delivering a consumable part to be used for replacement of the consumable part, of the acquired remaining amount and the predicted remaining number of days.

### BACKGROUND OF THE INVENTION

### Field of the Invention

The present invention relates to an image forming apparatus, a method for controlling the same, and an image forming system.

### Description of the Related Art

An image forming apparatus such as a printer, a copier, a facsimile machine, and the like is provided with a plurality of replaceable consumable parts (consumables) that are consumed as the image forming apparatus operates, such as a toner container, a recovered toner container, and the like, for example. These consumable parts eventually become unusable by degradation over time or by consumable material contained inside a container which configures the consumable part being used up.

In order to maintain good print quality in the image forming apparatus, a user or service engineer needs to periodically replace each consumable part. As a technique for prompting the replacement of such a consumable part, a technique is known in which the remaining amount of a consumable material such as toner accommodated in a container such as a toner container is predicted, and when a set number of days is reached, a notification is made to a maintenance server for performing maintenance of the consumable part, and delivery of the consumable part is automatically arranged.

Japanese Patent Laid-Open No. 2017-37596 discloses an image forming apparatus that predicts a remaining amount of toner, sets a number of days for delivery, issues a delivery request to a consumable maintenance server when the remaining amount of toner reaches the remaining amount corresponding to the number of days for delivery, and the next toner cartridge is delivered prior to all of the toner being used up. This hereby enables the occurrence of downtime of the image forming apparatus to be avoided while keeping a time interval for storage of the toner cartridges to a minimum that is necessary.

As described above, when using a method of issuing a delivery request for a consumable part from an image forming apparatus to a maintenance server, it may be difficult to appropriately determine a timing for delivery of the consumable part. For example, if the number of days taken for delivery from issuance of the delivery request to actual delivery of the consumable part to the installation location of the image forming apparatus is unknown, it is difficult to issue a delivery request at an appropriate time.

### SUMMARY OF THE INVENTION

The present invention provides a technique for, by making a notification from an image forming apparatus to a maintenance server of a remaining number of days in which a consumable part (a consumable) mounted to the image forming apparatus can be used, enabling an appropriate time for delivery of the consumable part to be decided.

According to one aspect of the present invention, there is provided an image forming apparatus, comprising: an acquisition unit configured to acquire a remaining amount of a consumable part that is detachably mounted to the image forming apparatus and is used for image forming; a prediction unit configured to predict a remaining number of days, which is a number of days remaining in which the consumable part can be used, based on a change of the remaining amount acquired by the acquisition unit; and a notification unit configured to notify a server apparatus, which performs processing for delivering a consumable part to be used for replacement of the consumable part, of the remaining amount and the remaining number of days predicted by the prediction unit.

According to another aspect of the present invention, there is provided an image forming system configured by an image forming apparatus and a server apparatus, wherein the image forming apparatus comprises: an acquisition unit configured to acquire a daily usage amount of a consumable part that is detachably mounted to the image forming apparatus and is used for image forming; a transmission unit configured to transmit the usage amount acquired by the acquisition unit to a server apparatus, which performs processing for delivering a consumable part to be used for replacement of the consumable part; a reception unit configured to receive, from the server apparatus, a number of days remaining in which the consumable part can be used; and a notification unit configured to perform a notification of the number of days remaining received by the reception unit, and the server comprises: a prediction unit configured to, based on the usage amount transmitted by the transmission unit of the image forming apparatus, predict a remaining number of days, which is the number of remaining days in which the consumable part can be used.

According to still another aspect of the present invention, there is provided a method for controlling an image forming apparatus, the method comprising: acquiring a remaining amount of a consumable part that is detachably mounted to the image forming apparatus and is used for image forming; predicting a remaining number of days, which is a number of days remaining in which the consumable part can be used, based on a change of the acquired remaining amount; and notifying a server apparatus, which performs processing for delivering a consumable part to be used for replacement of the consumable part, of the acquired remaining amount and the predicted remaining number of days.

Further features of the present invention will become apparent from the following description of exemplary embodiments (with reference to the attached drawings).

### BRIEF DESCRIPTION OF THE DRAWINGS

FIG. 1 is a block diagram showing an exemplary hardware configuration of an image forming apparatus.

FIG. 2 is a view showing an example of the transition of a remaining amount of a consumable part and prediction of a remaining number of days of the consumable part.

FIG. 3 shows examples of operation screens displayed on an operation unit of the image forming apparatus.

FIG. 4 is a flow chart showing a procedure of processing for notifying a maintenance server.

FIG. 5 is a view showing an example of notification data transmitted to the maintenance server.

FIG. 6 is a view showing an example of notification data transmitted to the maintenance server.

FIG. 7 is a view showing an example of notification data transmitted to the maintenance server.

FIG. 8 is a view showing an example of notification data transmitted to the maintenance server.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

### First Embodiment

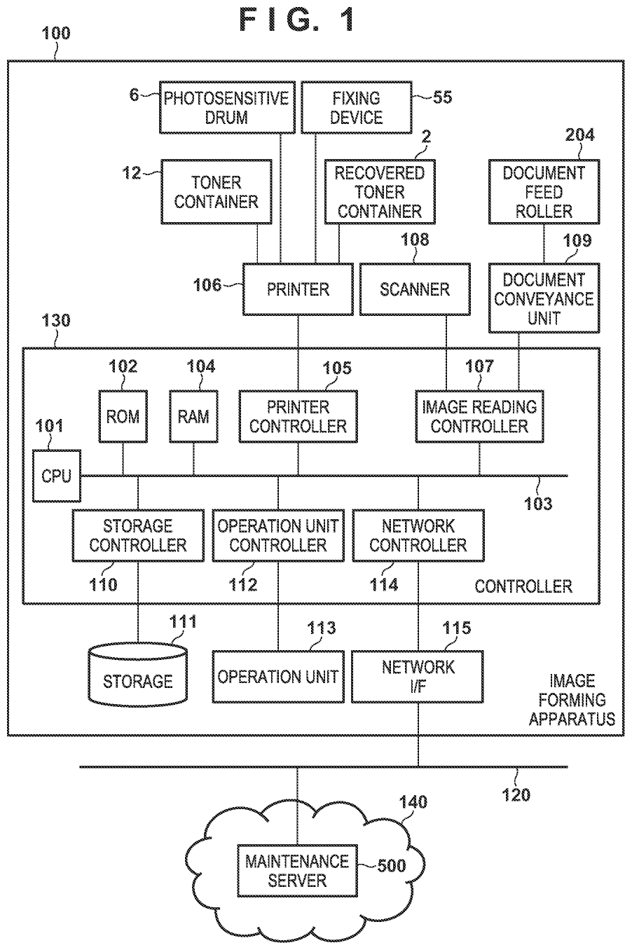

A first embodiment of the present invention will be described with reference to FIGS. 1 to 7.

<Image Forming Apparatus>

FIG. 1 is a block diagram showing an exemplary hardware configuration of an image forming apparatus 100 according to the present embodiment. The image forming apparatus 100 includes a controller 130 that includes a CPU (Central Processing Unit) 101. The image forming apparatus 100 includes a storage 111, a printer 106, a scanner 108, a document conveyance unit 109, and an operation unit 113 as hardware devices connected to the controller 130.

The controller 130 includes a ROM (Read Only Memory) 102, a RAM (Random Access Memory) 104, a printer controller 105, an image reading controller 107, a storage controller 110, and an operation unit controller 112. Each device configuring the controller 130 is connected to a bus 103. The printer controller 105, the image reading controller 107, the storage controller 110, and the operation unit controller 112 function as interfaces for the CPU 101 to control respective hardware devices.

The image forming apparatus 100 is mounted with many consumable parts, and each consumable part is configured to be replaceable by a user or a service engineer. For example, a toner container 12 and a recovered toner container 2 are configured so that they can be attached/detached with respect to the printer 106, and each is a consumable part that can be replaced by a user or a service engineer. In the present specification, the term “consumed” means, for the toner container 12, that the remaining amount of toner present in the container becomes equal to or less than a threshold value, and means, for the recovered toner container 2, that the amount of toner which was not used for image formation and was recovered in the container becomes greater than or equal to a threshold value. A consumable part having a low level of consumption, such as a photosensitive drum 6 or a fixing device 55, may be excluded from being a target of a notification of a remaining number of days, as described later, by not being treated as a replacement part.

Based on bitmap data generated by the controller 130, the printer 106 performs image formation by an electrophotographic method in which toner is fixed to a sheet to form an image. Note that the printer 106 may employ an inkjet method in which ink is discharged onto a sheet to form an image. Recording material for the electrophotographic method is toner, and recording material for the inkjet method is ink. Note that, in the present embodiment, a consumable part mounted to the image forming apparatus 100 is described as a consumable part that can be replaced by a user, but the present invention is not limited to this, and some consumable parts may be consumable parts that are replaced by a service engineer.

The controller 130, which includes the CPU 101, controls the entirety of the image forming apparatus 100. The CPU 101 activates an OS (operating system) by reading and executing a boot program stored in the ROM 102. The CPU 101 further executes, on the OS, a control program stored in the storage 111 or the ROM 102. The RAM 104 is used as a temporary storage area such as a main memory or a work area of the CPU 101.

The storage 111 is a nonvolatile storage device such as a HDD (Hard Disk Drive). The storage 111 stores various programs such as a control program and various application programs for controlling the entirety of image forming apparatus 100, and stores various data such as image data and setting data. In the present embodiment, the storage 111 also stores setting data, such as a remaining number of days of a consumable part, that is set using the operation unit 113.

The CPU 101 accesses the storage 111 via the storage controller 110. The CPU 101 controls the image forming apparatus 100 by executing a control program or an application program that is read from the storage 111 or the ROM 102 and loaded into the RAM 104.

Although the image forming apparatus 100 of the present embodiment employs a mode in which one CPU 101 executes respective processing shown in a flow chart described later by using a program loaded into one memory (the RAM 104), another mode may be employed. For example, the processing shown in the flow chart described later can be executed by causing a plurality of processors, RAMs, ROMs, and storages to cooperate. In addition, a configuration in which some processing is executed using a hardware circuit such as an ASIC or an FPGA can be adopted.

The CPU 101 controls the scanner 108 via the image reading controller 107 so as to read an image on a document to generate image data. The scanner 108 scans the document using an optical reading element such as a CCD, and converts image information of the document into electric signal data to thereby generate image data. Image data obtained by reading the image on the document is stored in the storage 111 and used for, for example, image forming processing by the printer 106.

The CPU 101 can also control the document conveyance unit 109, which has an automatic document feeder (ADF), so as to convey documents placed on a document table of the document conveyance unit 109 one by one to the scanner 108, and cause the scanner 108 to generate image data. Note that the document conveyance unit 109 includes a document feed roller 204 for feeding and conveying a document.

The operation unit controller 112 connects the operation unit 113 and the controller 130. The operation unit 113 functions as a display unit that displays information to a user, and an acceptance unit that accepts an instruction from the user. The operation unit 113 is provided with a touch panel display for displaying an operation screen and accepting an input from a user. The operation unit 113 may include hard keys such as a start key and a status check/cancel key. The status check/cancel key is used to display, on the display unit of the operation unit 113, a status screen for confirming the status of the image forming apparatus and giving an instruction to cancel a job.

A network controller 114 controls a network I/F (interface) 115. The network I/F 115 is connected to a wired LAN 120 via a LAN cable. The network I/F 115 communicates with an external apparatus connected via the wired LAN 120. For example, the network I/F 115 can communicate with a maintenance server 500 which is on the Internet 140. In the present embodiment, the maintenance server 500 is an example of a server apparatus that performs processing for delivering a consumable part to be used for replacement of a consumable part in the image forming apparatus 100.

<Predicting Remaining Number of Days of Consumable Part>

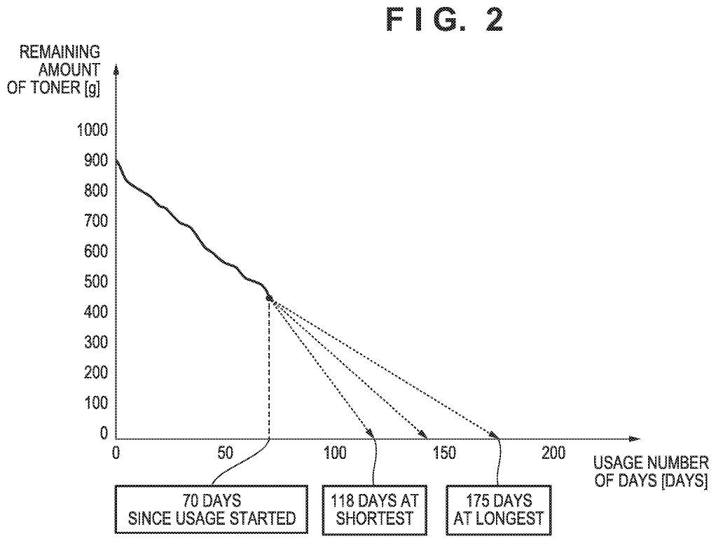

FIG. 2 illustrates an example of transition of the remaining amount of toner contained in one toner container within a defined time interval in the past. The horizontal axis represents the number of days elapsed from the starting date of use of the toner in the toner container (a usage number of days), and the vertical axis represents the remaining amount of toner in the toner container. FIG. 2 shows the transition (change) of the toner remaining amount on a daily basis by subtracting a daily toner usage amount from an initial toner amount (0 days).

FIG. 2 illustrates an example of, at a time when 70 days have elapsed since the use of new toner in the toner container was started, predicting the day when there ceases to be toner in the toner container (that is, the day when the remaining amount of toner becomes 0). More specifically, based on the remaining amount of toner at that time and the statistic of the average toner usage amount per day in the time interval of the last 30 days, the day when there will cease to be toner in the toner container is predicted. In the present example, a prediction result that there will cease to be toner inside the toner container in as few as 48 remaining days (118 days from the starting date of use) and as many as 105 remaining days (175 days from the start of use) is obtained. That is, it is predicted that the number of days until there ceases to be toner inside the toner container (in other words, the number of days remaining in which the toner container, which is a consumable part, can be used (the remaining number of days)) is 48 days at the shortest and 105 days at the longest.

As described above, in a case where a plurality of predicted values are obtained as the prediction result of the remaining number of days of a toner container (a consumable part), any of them may be adopted as the predicted value of the remaining number of days. For example, if the image forming apparatus 100 will become inoperable when, for example, a toner container becomes unusable, the shortest predicted value can be employed to reduce the likelihood of downtime occurring for the image forming apparatus 100.

In the present example, considering that the estimation accuracy of the average toner usage amount per day may be low when the toner use initially starts, the timing for starting the prediction of the remaining number of days of the toner container is set in advance to a timing when 70 days have elapsed from the date when usage of the toner container started. Note that the timing at which the prediction of the remaining number of days is started can be set to an arbitrary timing.

The prediction of the remaining number of days of the consumable part may be performed periodically (for example, every second), or may be performed irregularly (for example, every time one image is formed or every time an image of one page is formed). As described above, by repeating the prediction of the remaining number of days, the remaining number of days can be predicted more accurately for a user whose usage of the image forming apparatus 100 changes every day based on the characteristics of the usage.

The CPU 101 stores the remaining amount and the remaining number of days (predicted values) of the consumable part acquired as described above in a storage device such as the RAM 104 or the storage 111, and updates the remaining amount and the remaining number of days stored in the storage device every time the remaining amount and the remaining number of days are acquired. The CPU 101 may also store the acquired remaining amount and remaining number of days in a storage device provided in the consumable part, so that the remaining amount and remaining number of days can be referred to after re-mounting even if the consumable part is detached from and reattached to the image forming apparatus 100.

<Example of Operation Screens>

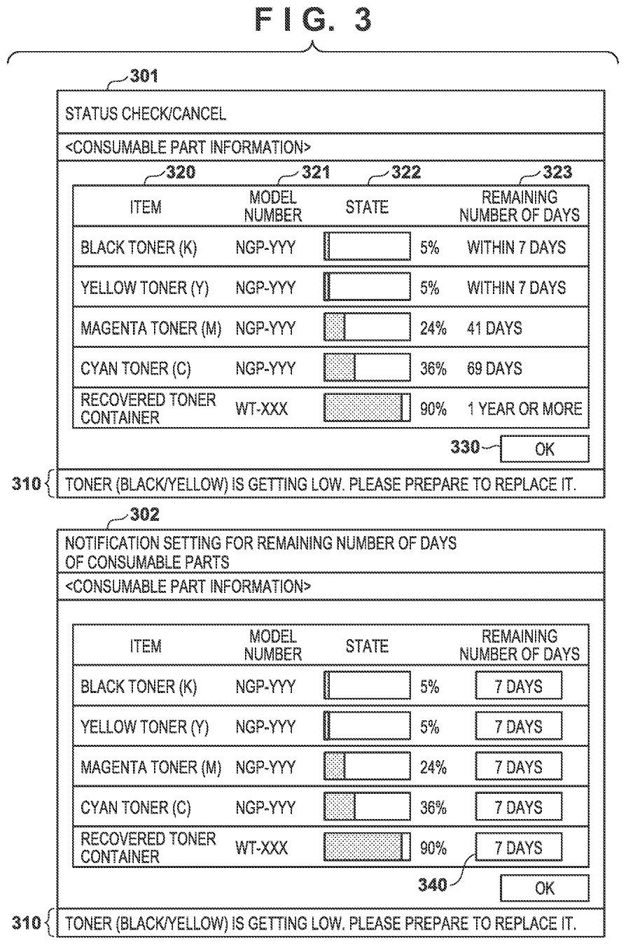

FIG. 3 shows examples of operation screens displayed on the operation unit 113 of the image forming apparatus 100. Each operation screen of FIG. 3 can be displayed on the operation unit 113 based on display data generated by the CPU 101 reading and executing a program stored in the ROM 102 or the storage 111.

In a status display region 310, which is a part of a display region of the operation unit 113, a message related to a maintenance events occurring in the image forming apparatus 100 is displayed. FIG. 3 shows, as an example, a state in which a message indicating that the remaining amounts of black toner and yellow toner are low and prompting the user to prepare for replacement of the toner container is displayed in the status display region 310. Note that, in a case where a plurality of maintenance events have occurred, messages corresponding to the respective maintenance events are displayed in order.

(Operation Screen 301)

An operation screen 301 is an example of a status check/cancel screen. If the CPU 101 detects that the user has pressed a status check key (not shown) arranged on the operation unit 113, it displays the operation screen 301 on the operation unit 113. The operation screen 301 includes display fields 320 to 323 for displaying an item, a model number, a state, and a remaining number of days of a consumable part. An OK key 330 is used to instruct termination of the display of the operation screen 301. If the OK key 330 is pressed, the CPU 101 terminates the display of the operation screen 301, and displays another screen (not shown) on the operation unit 113.

In a display field 320, items of consumable parts such as toner containers corresponding to respective colors, a recovered toner container, photosensitive drums corresponding to respective colors, a fixing device, and a document feed roller are displayed in a list. The model number of the consumable parts is displayed in a display field 321. The model number is identification information for identifying consumable parts mounted to different types of image forming apparatuses, such as a high speed model or a low speed model, and is used by a user to order a consumable part.

A display field 322 displays states of the consumable parts and is configured by, for example, indicators indicating the remaining amount of the consumable parts and remaining amounts indicating the level of consumption of the consumable parts. In this example, the remaining amount is expressed as a percentage. Note that, in a case where the remaining amount is less than a predetermined threshold value (for example, 5%), the predetermined threshold value may be displayed as the remaining amount in the display field 322 instead of the actual remaining amount. This is to suppress replacement until the consumable part is used up to the end. If the remaining amount falls below the predetermined threshold value, the user may replace the consumable part even though the consumable part can still be used. Therefore, by displaying the predetermined threshold value as the remaining amount instead of the actual remaining amount to indicate that the consumable part can be used, the user can be encouraged to use the consumable part to the end.

In a display field 323, values indicating the remaining number of days (a predicted value) of the consumable part are displayed. In the display field 323, a display that is intuitively easy for the user to understand may be given. In the present example, display control is performed in which “1 year or more” is displayed in the display field 323 for a consumable part whose remaining number of days is 365 days or more. This display control is performed in order to allow the user to intuitively understand that replacement will not occur for a while with respect to a consumable part for which replacement will not occur for a while. There is no limitation to display control in which the threshold value is 365 days as described above, and, for example, display control in which the threshold value is six months may be performed. In such a case, display control is performed in which “six months or more” is displayed in the display field 323 for a consumable part whose remaining number of days is six months or more.

In addition, configuration may be taken to perform display control in which “within 7 days” is displayed in the display field 323 for a consumable part whose remaining number of days (a predicted value) is less than 8 days. This is to suppress replacement until the consumable part is used up to the end. If the remaining number of days falls below the predetermined threshold value, the user may replace the consumable part even though the consumable part can still be used. Therefore, by displaying the predetermined threshold value as the remaining number of days instead of displaying the actual remaining number of days to indicate that the consumable part can be used, the user can be encouraged to use the consumable part to the end. When the remaining number of days reaches 0 days, a message prompting the replacement of the consumable part (for example, displaying “need to replace”) may be displayed in the display field 323. By such display control, information in accordance with the remaining number of days of the consumable part can be presented to a user in a display form that enables the user to intuitively understand the information.

(Operation Screen 302)

An operation screen 302 is an example of a setting screen for performing a notification setting of the remaining number of days of the consumable part. When a menu screen (not shown) is displayed on the operation unit 113 and a menu corresponding to the notification setting of the remaining number of days of the consumable part is selected on the menu screen, the CPU 101 displays the operation screen 302 on the operation unit 113. Similar to the operation screen 301, the operation screen 302 includes display fields for an item, a model number, and a state of a consumable part. The operation screen 302 has an input field 340 of a setting value (a set number of days) of the remaining number of days of a consumable part, which indicates a timing of notifying the maintenance server 500.

The image forming apparatus 100 (the CPU 101) accepts the input of a setting value in the input field 340 from a user on the operation screen 302. The user can enter a setting value of a remaining number of days for performing a notification to the maintenance server 500 for each displayed consumable part mounted to the image forming apparatus 100. If the OK button is pressed in a state where a setting value has been input in the input field 340, the input setting value is stored in the storage 111. If the remaining number of days (predicted value) of the consumable part reaches the setting value (set number of days) set on the operation screen 302 for each consumable part, the image forming apparatus 100 notifies the maintenance server 500 of information relating to the remaining number of days of the consumable part. As a result, the image forming apparatus 100 can arrange for delivery of the consumable part on the maintenance server 500.

Although FIG. 3 shows an example in which the user sets a timing for notifying the maintenance server 500, the setting may be performed by a service engineer using the operation screen 302 or another operation screen (not shown).

<Processing for Notifying Maintenance Server>

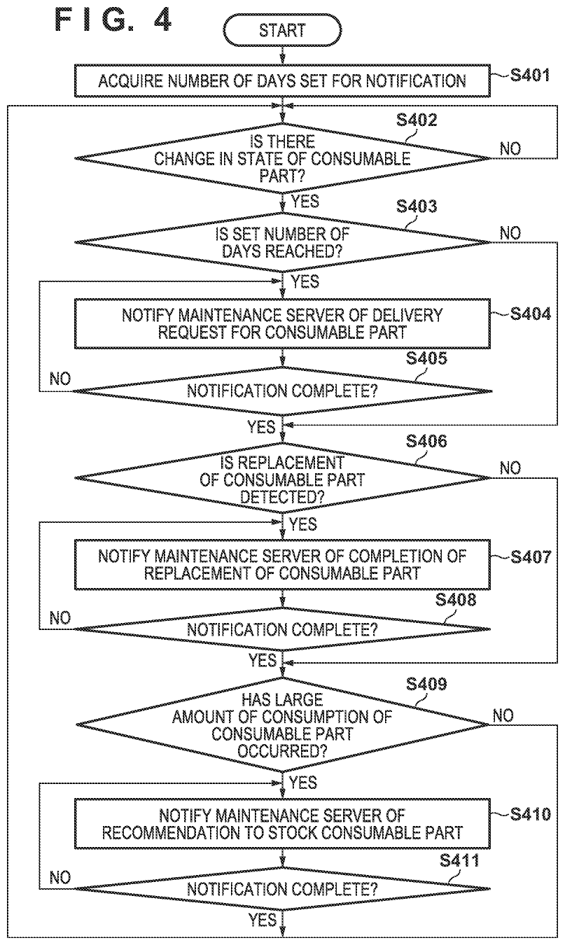

Next, referring to the flow chart of FIG. 4, processing for making a notification from the image forming apparatus 100 to the maintenance server 500 will be described. FIG. 4 is a flow chart showing a procedure of the notification processing executed by the CPU 101 in the image forming apparatus 100. The processing of each step in FIG. 4 is implemented in the image forming apparatus 100 by the CPU 101 reading and executing a program stored in the ROM 102 or the storage 111. In the notification processing of FIG. 4, for example, in a case where the predicted value of the remaining number of days of a consumable part reaches a setting value (a set number of days) set using the operation screen 302, the image forming apparatus 100 notifies the maintenance server 500 of the remaining number of days of the consumable part.

First, in step S401, the CPU 101 acquires the number of days set for notification of the remaining number of days, which is set using the operation screen 302, from the storage 111, and stores the acquired number of days in the RAM 104. Next, in step S402, the CPU 101 determines whether or not a state change of the consumable part has occurred. A state change indicates that, for example, a change of the remaining amount or the remaining number of days of the consumable part, a replacement of the consumable part, or a large amount of consumption greater than or equal to than the threshold value of the consumable part is detected. The change in the remaining amount or the remaining number of days of the consumable part and the detection of a large amount of consumption greater than or equal to the threshold value of the consumable part can be determined by using the transition (change) of the remaining amount of the consumable part and the remaining number of days obtained by the processing described with reference to FIG. 2.

The CPU 101 repeats the determination in step S402 as long as a state change of the consumable part has not occurred, and if a state change of the consumable part has occurred, advances the processing to step S403. Note that, similarly to the prediction of the remaining number of days of the consumable part, the determination of step S402 may be performed periodically (for example, every second), or may be performed irregularly (for example, every time one image is formed or every time an image of one page is formed).

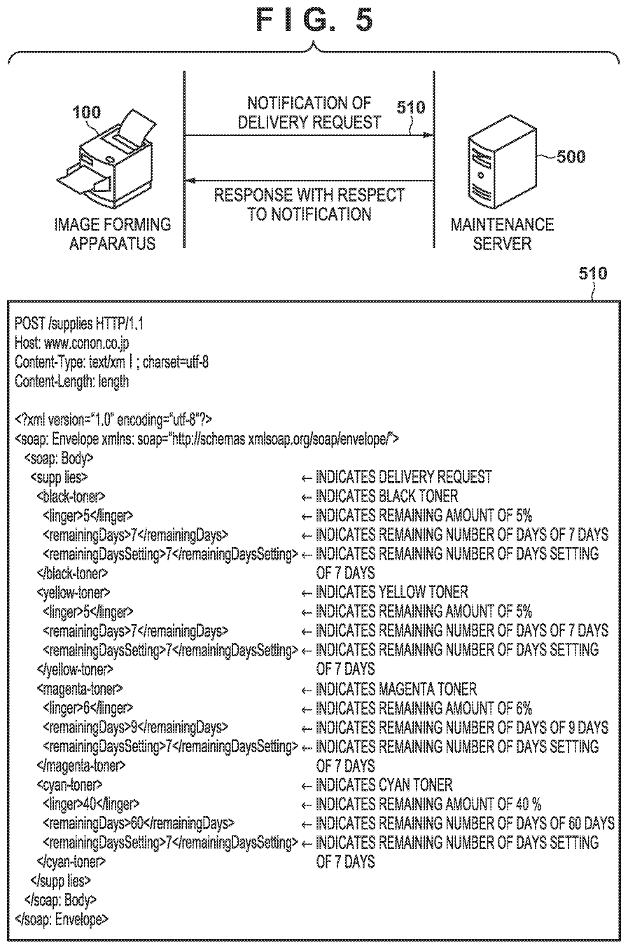

In step S403, the CPU 101 determines whether or not the remaining number of days of the consumable part obtained by the prediction processing has reached the set number of days. If the remaining number of days reaches the set number of days, the CPU 101 advances the processing to step S404, and if the remaining number of days does not reach the set number of days, advances the processing to step S406. In step S404, the CPU 101 notifies the maintenance server 500 of a delivery request of the consumable part, and advances the processing to step S405. The CPU 101 includes the remaining number of days of the consumable part in the notification to be transmitted to the maintenance server 500 to thereby notify the maintenance server 500 of the remaining number of days. In the present embodiment, the notification of step S404 may also include the remaining amount of the consumable part, as will be described later with reference to FIG. 5.

In step S405, the CPU 101 determines whether or not the notification to the maintenance server 500 completed based on whether or not a response indicating whether or not the notification from the image forming apparatus 100 was successfully received has been received from the maintenance server 500. If the CPU 101 receives a response from the maintenance server 500 indicating that reception of the notification failed, it determines that the notification has not completed, returns the processing to step S404, and notifies the server again. In contrast, if the CPU 101 receives a response from the maintenance server 500 indicating that reception of the notification succeeded, it determines that the notification has completed, and advances the processing to step S406.

In step S406 the CPU 101 determines whether or not replacement of the consumable part is detected. The CPU 101 advances the processing to step S407 if it detects replacement of the consumable part, and advances the processing to step S409 if it does not detect replacement. In step S407, the CPU 101 notifies the maintenance server 500 of completion of the replacement of the consumable part, and advances the processing to step S408.

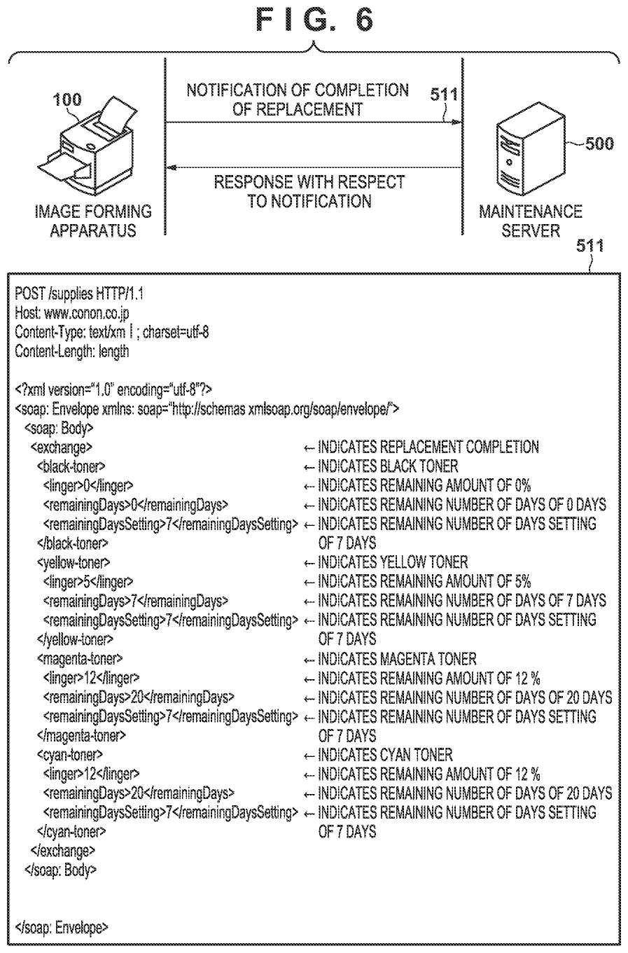

In the present embodiment, the notification of step S407 can include the remaining amount and the remaining number of days of the consumable part, as will be described later with reference to FIG. 6. For example, in a case where a consumable part that is a second-hand product is mounted in accordance with a replacement, a remaining amount and a remaining number of days read from a storage device of the consumable part are included in the notification to the maintenance server 500. In addition, in a case where a new consumable part is mounted in accordance with a replacement, since the remaining amount and the remaining number of days are not stored in the storage device included in the consumable part, for example, information such as 100% for the remaining amount and 364 days for the remaining number of days is included in the notification.

That is, if the replacement of a consumable part is detected, the CPU 101 notifies the maintenance server 500 of the remaining number of days and the remaining amounts of the consumable part mounted in accordance with the replacement. As a result, the maintenance server 500 can obtain information relating to the replacement of the consumable part and the information relating to the consumable part mounted in accordance with the replacement. At this time, the CPU 101 may notify the maintenance server 500 of the remaining number of days and the remaining amount of a consumable part that has not been replaced, concurrently with making a notification of the remaining number of days and the remaining amount of a consumable part that has been replaced. As a result, the maintenance server 500 can obtain not only information regarding a consumable part that has been replaced but also information regarding a consumable part that has not been replaced.

In step S408, the CPU 101 determines whether or not the notification to the maintenance server 500 completed based on whether or not a response indicating whether or not the notification from the image forming apparatus 100 was successfully received has been received from the maintenance server 500. If the CPU 101 receives a response from the maintenance server 500 indicating that reception of the notification failed, it determines that the notification has not completed, returns the processing to step S407, and performs the notification again. In contrast, if the CPU 101 receives a response from the maintenance server 500 indicating that reception of the notification succeeded, it determines that the notification has completed, and advances the processing to step S409.

In step S409, when processing for acquiring a remaining amount of and a remaining number of days (predicted values) of a consumable part is executed, the CPU 101 determines whether or not a large amount of consumption (that is, a large amount of toner consumption) has occurred for a consumable part. If it is determined that a large amount of toner consumption has occurred, the CPU 101 advances the processing to step S410, and if it is determined that a large amount of toner consumption has not occurred, the CPU returns the processing to step S402. For example, the CPU 101 determines that a large amount of toner consumption has occurred in a case where it has detected that the daily toner usage amount has exceeded a predetermined threshold value (or in a case where it repeatedly detects this).

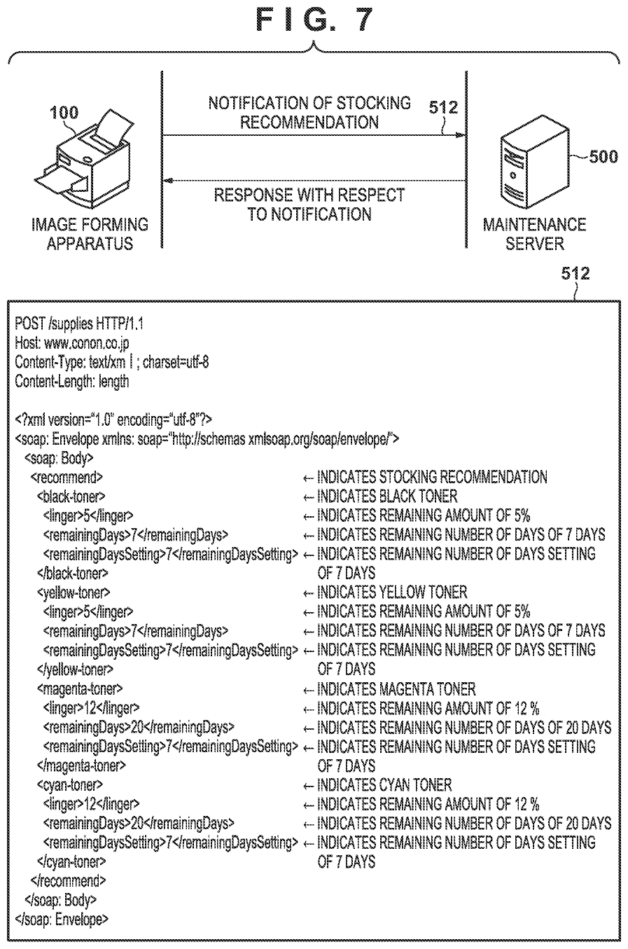

If a large amount of toner has been consumed, whether before or after the maintenance server 500 is notified in step S404, it can be judged that there is a high possibility of running out of toner before a new toner container is delivered to the installation location of the image forming apparatus 100. For this reason, in step S410, the CPU 101 transmits to the maintenance server 500 a notification indicating that stocking the consumable part at the installation location of the image forming apparatus 100 is recommended. In the present embodiment, the remaining amount and the remaining number of days of the consumable part may be included in the notification, as will be described later with reference to FIG. 7.

In step S411, the CPU 101 determines whether or not the notification to the maintenance server 500 completed based on whether or not a response indicating whether or not the notification from the image forming apparatus 100 was successfully received has been received from the maintenance server 500. If the CPU 101 receives a response from the maintenance server 500 indicating that reception of the notification failed, it determines that the notification has not completed, returns the processing to step S410, and performs the notification again. In contrast, if the CPU 101 receives a response from the maintenance server 500 indicating that reception of the notification succeeded, it determines that the notification has completed, and returns the processing to step S402.

Note that, a requirement for repeating the notification for a case of having received, in step S405, step S408, and step S411, a response (a notification error) indicating failure to receive a notification from the image forming apparatus 100 may be defined in advance. For example, conditions indicating a notification interval and a number of notifications may be defined in advance, such that the notification is repeated at intervals of 5, 10, 15, 20, 25, or 30 minutes and the notification is repeated limitlessly after 30 minutes have elapsed.

<Examples of Notification Data Transmitted to Maintenance Server>

Next, referring to FIGS. 5 to 7, the notification processing in step S404, step S407, and step S410 in the flow chart of FIG. 4 will be further described. In the present example, description is given for a case of performing a notification from the image forming apparatus 100 to the maintenance server 500 using SOAP (Simple Object Access Protocol) as the communication protocol, but the notification can be performed using another communication protocol.

In step S404, S407, and S410 of FIG. 4, a notification (request) configured by XML data is transmitted from the image forming apparatus 100 to the maintenance server 500. The maintenance server 500 returns a response to image forming apparatus 100 indicating whether or not it was able to successfully receive the notification from the image forming apparatus 100 (whether or not the notification was successfully received).

FIG. 5 shows an example of notification data for notifying a delivery request of a consumable part transmitted from the image forming apparatus 100 to the maintenance server 500 in step S404. Notification data 510 comprises XML data including a tag indicating a delivery request, tags and data indicating the remaining amounts of toner in toner containers, tags and data indicating the remaining number of days of the toner containers, and tags and setting values indicating setting values of the remaining number of days of the toner containers (set number of days).

The notification data 510 shown in FIG. 5 is an example of data transmitted in a case where the remaining number of days in the toner containers for black and yellow toner reach the set number of days. In the present example, although the toner containers for magenta and cyan toner have not reached the set number of days, information relating to these toner containers (the remaining amount, the remaining number of days, and the set number of days) is also notified concurrently. That is, information relating to a toner container whose remaining number of days has not reached the set number of days is also notified. This information can be used to determine whether or not toner containers for magenta and cyan toners should be delivered at the same time.

Upon reception of the notification data 510, the maintenance server 500 can decide to deliver toner containers for black and yellow toner, for which the remaining number of days has reached the set number of days, to the installation location of the image forming apparatus 100. In addition, for example, regarding the toner container for magenta toner, while its remaining number of days has not reached the set number of days, it only has two remaining days until the set number of days is reached, and thus the maintenance server 500 may decide to deliver the toner container for magenta toner at the same time. In contrast, the maintenance server 500 decides to not deliver a toner container for cyan toner because the remaining number of days for the toner container for cyan toner is 60 days and it is predicted that there is a sufficient time interval before toner runs out.

As described above, in a case where the remaining number of days of any of a plurality of consumable parts mounted to the image forming apparatus 100 reaches a set number of days, the image forming apparatus 100 can concurrently notify the maintenance server 500 of the remaining number of days and the remaining amount for each of the plurality of consumable parts. As a result, it becomes possible to determine whether or not a consumable part (toner container) for which the remaining number of days has not reached the set number of days should be delivered at the same time as a consumable part for which the remaining number of days has reached the set number of days.

FIG. 6 shows an example of notification data, for notifying completion of the replacement of a consumable part, transmitted from the image forming apparatus 100 to the maintenance server 500 in step S407. Notification data 511 comprises XML data including a tag indicating the completion of replacement, tags and data indicating the remaining amounts of toner in toner containers, tags and data indicating the remaining number of days of the toner containers, and tags and setting values indicating setting values of the remaining number of days of the toner containers (set number of days).

Notification data 511 shown in FIG. 6 is an example of data transmitted in a case where a toner container for black toner is replaced with a new toner container in the image forming apparatus 100. This allows the maintenance server 500 to know information (such as the remaining number of days) regarding toner containers of colors other than black toner that were not replaced.

FIG. 7 shows an example of notification data, for notifying a stocking recommendation for a consumable part, transmitted from the image forming apparatus 100 to the maintenance server 500 in step S410. Notification data 512 comprises XML data including a tag indicating a stocking recommendation, tags and data indicating the remaining amounts of toner in toner containers, tags and data indicating the remaining number of days of the toner containers, and tags and setting values indicating setting values of the remaining number of days of the toner containers (set number of days). In the present embodiment, a stocking recommendation indicates that the consumable part needs to be ordered regardless of the remaining number of days available for the consumable part.

Notification data 512 shown in FIG. 7 is an example of data transmitted in a case where a large amount of consumption of black toner has occurred. The notification data 512 includes information (tag) indicating a stocking recommendation for the toner container of toner (black toner) of some colors for which a large amount of toner consumption has occurred, and also includes information such as the remaining number of days for the toner containers of each color of toner. Upon receiving the notification data 512, the maintenance server 500 can decide to deliver, to the installation location of the image forming apparatus 100, toner container of colors for which a stocking recommendation was notified.

Note that the notification data 512 may include information such as the remaining number of days only for a toner container that is a target of a notification for a stocking recommendation, rather than for the toner containers of all colors of toner. In this instance, the maintenance server 500 may determine that there is a stocking recommendation for a toner container for which information such as the remaining number of days is notified. Further, in the present embodiment, a notification for a stocking recommendation is transmitted to the maintenance server 500 in a case where a large amount of toner consumption, but a screen for prompting the user to order the toner that was consumed in a large amount may be displayed on the operation unit 113. At this time, configuration may be taken such that the user can select whether or not to place an order on the screen and the notification data 512 shown in FIG. 7 may be transmitted to the maintenance server 500 in a case where the user instructs the order.

As described above, in the present embodiment, the image forming apparatus 100 acquires the remaining amount of a consumable part (such as toner container or recovered toner container) that is used for image formation and is detachably mounted to the apparatus. This remaining amount is, for example, a remaining amount of the stored toner (consumable material) in the case of toner container, or a remaining toner amount that can be stored in the case of the recovered toner container. The image forming apparatus 100 predicts the remaining number of days, which is the number of days remaining in which the consumable part can be used, based on the acquired change (transition) of the remaining amount. The image forming apparatus 100 notifies the predicted remaining number of days to the maintenance server 500 (a server apparatus) which performs processing for delivery of a consumable part to be used for replacement of the consumable part.

In this manner, by performing a notification from the image forming apparatus 100 to the maintenance server 500 of the remaining number of days in which a consumable part (a consumable) mounted to the image forming apparatus 100 can be used, an appropriate delivery timing for the consumable part becomes possible to be decided in the maintenance server 500. As a result, the consumable part becomes possible to be delivered to the installation location of the image forming apparatus 100 at an appropriate time. In addition, the maintenance server 500 becomes possible to appropriately perform processing for delivery of the consumable part, such as deciding an appropriate delivery date for the consumable part and deciding to simultaneously deliver a plurality of consumable parts (efficient delivery of a plurality of consumable parts when possible), based on the remaining number of days of the consumable part.

In addition, in the present embodiment, the image forming apparatus 100 sets the remaining number of days for performing a notification to the maintenance server 500 in accordance with an instruction given by the user via operation screen 302, for example. In such a case, in a case where the remaining number of days of a consumable part reaches the set number of days, the image forming apparatus 100 notifies the maintenance server 500 of the remaining number of days. In this manner, by notifying the maintenance server 500 at a timing when the remaining number of days reaches the set number of days, it becomes possible to make a notification to the maintenance server 500 so that the consumable part is reliably delivered to the set location of the image forming apparatus 100 prior to the remaining amount of the consumable part becoming 0.

### Second Embodiment

In the first embodiment, description was given regarding a case of, in the image forming apparatus 100, predicting a remaining number of days of a consumable part (toner container), and notifying the remaining amount of the consumable part and the remaining number of days to the maintenance server 500. In the second embodiment, description is given regarding a case where the image forming apparatus 100 notifies the maintenance server 500 of the daily toner usage amount, and the maintenance server 500 estimates the transition (change) of a toner remaining amount in a toner container, and predicts the remaining number of days of the toner container. Hereinafter, descriptions of the same components as those of the first embodiment, such as the hardware configuration of the image forming apparatus, will be omitted.

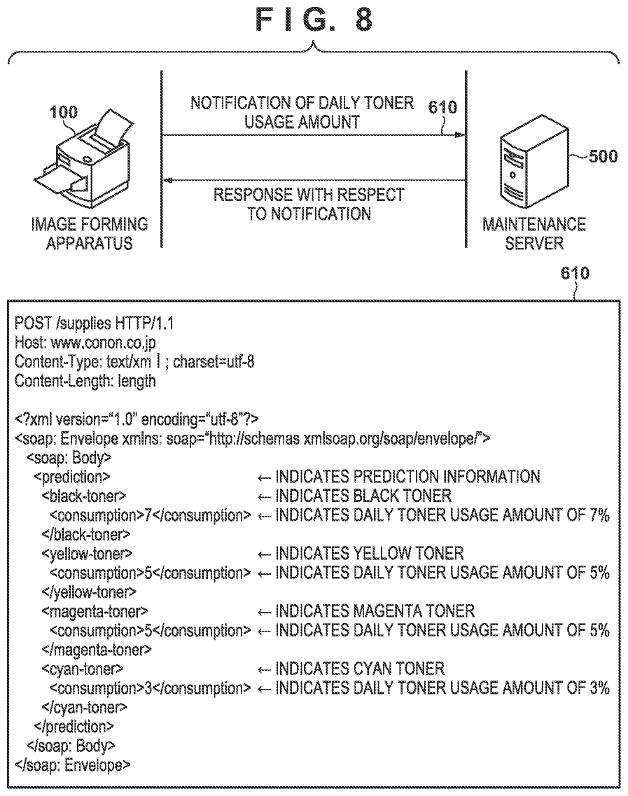

In the present embodiment, notification data 610 shown in FIG. 8 is transmitted from the image forming apparatus 100 to the maintenance server 500 in place of the notification data 510 (FIG. 5) in step S404 (FIG. 4). As shown in FIG. 8, the notification data 610 includes a daily toner usage amount for the toner container of each color. Specifically, the notification data 610 is configured by XML data that includes a tag indicating prediction information, a tag indicating the toner container of each color (black, yellow, magenta, and cyan), and a daily toner usage amount of each color.

The notification data 610 is transmitted from the image forming apparatus 100 to the maintenance server 500 at a period of once every day or every several days, for example. Based on the toner usage amounts included in the notification data 610, the maintenance server 500 estimates the transition of the toner remaining amount as shown in FIG. 2, and predicts the remaining number of days of each toner container. Based on this prediction result, the maintenance server 500 decides appropriate delivery timings of the toner containers (consumable parts) in the same manner as in the first embodiment.

In this embodiment, description was given regarding a case of notifying toner usage amounts for toner containers, but configuration may be taken to notify the maintenance server 500 of a daily usage amount of another consumable part that is not a toner container, such as a recovered toner container. In such a case, the maintenance server 500 predicts the remaining number of days of the consumable part based on the received notification.

As described above, in the present embodiment, the image forming apparatus 100 acquires a daily usage amount of a consumable part (such as toner container or recovered toner container) that is used for image formation and is detachably mounted to the apparatus. The image forming apparatus 100 notifies the maintenance server 500 of the acquired usage amount, thereby causing the maintenance server 500 to acquire, from that usage amount, the remaining amount of the consumable part, and predict, based on a change of the remaining amount, a remaining number of days, which is the number of days remaining in which the consumable part can be used. In this manner, by enabling the maintenance server 500 to predict the remaining number of days of a consumable part mounted to the image forming apparatus 100, an appropriate delivery timing for the consumable part becomes possible be decided in the maintenance server 500. As a result, the consumable part becomes possible to be delivered to the installation location of the image forming apparatus 100 at an appropriate timing.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-144029, filed Jul. 31, 2018, which is hereby incorporated by reference herein in its entirety.

What is claimed is:

1. An image forming apparatus, comprising:
an acquisition unit configured to acquire a remaining amount of a consumable part that is detachably mounted to the image forming apparatus and is used for image forming;
a prediction unit configured to predict a remaining number of days, which is a number of days remaining in which the consumable part can be used, based on a change of the remaining amount acquired by the acquisition unit; and
a notification unit configured to notify a server apparatus, which performs processing for delivering a consumable part to be used for replacement of the consumable part, of the remaining amount and the remaining number of days predicted by the prediction unit.

2. The image forming apparatus according to claim 1, further comprising:
a setting unit configured to set, in accordance with an instruction from a user, a remaining number of days for performing a notification to the server apparatus,
wherein the notification unit notifies the server apparatus of the remaining number of days and the remaining amount when the remaining number of days predicted by the prediction unit reaches the set number of days set by the setting unit.

3. The image forming apparatus according to claim 2, wherein
the setting unit sets a remaining number of days for performing a notification to the server apparatus for each consumable part mounted to the image forming apparatus, and
when the remaining number of days reaches the set number of days for any one of a plurality of consumable parts mounted to the image forming apparatus, the notification unit notifies the server apparatus of the remaining number of days and the remaining amount for each of the plurality of consumable parts concurrently.

4. The image forming apparatus according to claim 1, wherein
the prediction unit periodically predicts the remaining number of days or predicts the remaining number of days each time image formation is performed.

5. The image forming apparatus according to claim 1, further comprising:
a detection unit configured to detect replacement of the consumable part mounted to the image forming apparatus,
in a case where replacement of the consumable part is detected by the detection unit, the notification unit notifies the server apparatus of the remaining number of days and the remaining amount of a consumable part mounted in accordance with the replacement.

6. The image forming apparatus according to claim 5, wherein
the notification unit notifies the server apparatus of the remaining number of days and the remaining amount for a consumable part that was not replaced, concurrently with notifying the remaining number of days and the remaining amount of the consumable part for which the replacement was performed.

7. The image forming apparatus according to claim 1, wherein
the acquisition unit acquires the remaining amount from a daily usage amount of the consumable part, and
in a case where the daily usage amount exceeds a predetermined threshold value, the notification unit further transmits to the server apparatus a notification regarding an order of the consumable part for an installation location of the image forming apparatus.

8. An image forming system configured by an image forming apparatus and a server apparatus, wherein
the image forming apparatus comprises:
an acquisition unit configured to acquire a daily usage amount of a consumable part that is detachably mounted to the image forming apparatus and is used for image forming;
a transmission unit configured to transmit the usage amount acquired by the acquisition unit to a server apparatus, which performs processing for delivering a consumable part to be used for replacement of the consumable part;
a reception unit configured to receive, from the server apparatus, a number of days remaining in which the consumable part can be used; and
a notification unit configured to perform a notification of the number of days remaining received by the reception unit, and
the server comprises:
a prediction unit configured to, based on the usage amount transmitted by the transmission unit of the image forming apparatus, predict a remaining number of days, which is the number of remaining days in which the consumable part can be used.

9. A method for controlling an image forming apparatus, the method comprising:
acquiring a remaining amount of a consumable part that is detachably mounted to the image forming apparatus and is used for image forming;
predicting a remaining number of days, which is a number of days remaining in which the consumable part can be used, based on a change of the acquired remaining amount; and
notifying a server apparatus, which performs processing for delivering a consumable part to be used for replacement of the consumable part, of the acquired remaining amount and the predicted remaining number of days.
